(19) United States
(12) Patent Application Publication
(10) Pub. No.: US 2026/0178106 A1
(43) Pub. Date: Jun. 25, 2026

(54) METHOD AND SYSTEM FOR MANAGING POWER CONSUMPTION OF HOUSEHOLD DEVICES

(71) Applicant: ELECTROLUX APPLIANCES AKTIEBOLAG, Stockholm (SE)

(72) Inventors: Alex VIROLI, Viale Bologna (IT); Massimo NOSTRO, Forli (IT); Massimo ZANGOLI, Forli (IT); Fabio ANGELI, Forli (IT); Filippo MARTINI, Forli (IT)

(73) Assignee: ELECTROLUX APPLIANCES AKTIEBOLAG, Stockholm (SE)

(21) Appl. No.: 19/128,816

(22) PCT Filed: Sep. 19, 2023
(86) PCT No.: PCT/EP2023/075761

§ 371 Date: May 9, 2025

(30) Foreign Application Priority Data
Nov. 10, 2022 (GB) 2216781.1

(51) Int. Cl. G06F 1/3287; G06F 1/26; G06F 1/3203; G06F 1/3206; G06F 1/3296

(52) U.S. Cl. CPC G06F 1/3287; G06F 1/26; G06F 1/3203; G06F 1/3206; G06F 1/3296

(57) ABSTRACT

A computer implemented method is disclosed for managing a plurality of household devices associated with a user. The method may include, if an instant power consumption of the plurality of household devices does not comply with a threshold power consumption: providing a plurality of setting scenarios for allowing the instant power consumption of the plurality of household devices to comply with the threshold power consumption, each setting scenario corresponding to at least one of (i) one or more settings of each of more than one of the plurality of household devices and (ii) one or more settings of at least one first household device of the plurality of household devices conditional on a current state of at least one second household device of the plurality of household devices. They method may include receiving a user selection of a setting scenario among the plurality of setting scenarios.

### TECHNICAL FIELD

The present disclosure generally relates to a method (and a corresponding system) for managing an electric power consumption of household devices.

### BACKGROUND ART

The background of the present disclosure is hereinafter introduced with the discussion of techniques relating to its context. However, even when this discussion refers to documents, acts, artifacts and the like, it does not suggest or represent that the discussed techniques are part of the prior art or are common general knowledge in the field relevant to the present disclosure.

Nowadays, the management of the electric power consumption (hereinafter, concisely, power consumption) has become a very important and complex issue.

Making reference to household environments, consumers are more and more concerned in saving energy and/or energy bills, especially considering the growing number of household devices in household environments. Just as an example, the household devices in a household environment may typically comprise small appliances (such as microwave ovens, toasters, humidifiers, food processors and coffeemakers) and large appliances (such as freezers, refrigerators, water coolers, ice makers, kitchen stoves, cooking hobs, ovens and air conditioners).

While some household devices may include power consumption-saving features, this is not a guarantee that the consumer may be able to maximize energy savings.

### SUMMARY

The Applicant has realized that power consumption in household environments is highly variable, and is strongly affected by factors such as day of the week (for example, during a working day, highest power consumptions may be expected to mainly occur during morning and evening, while during weekends power consumption may be expected to be more evenly distributed), and period of the year (such as holidays and seasons).

In order to avoid overloads (e.g., to avoid that a maximum power threshold of the power grid is exceeded), reduced operation or malfunctions, solutions aimed at managing the power consumption may need to take into account at least some of the above-mentioned factors. Some existing solutions are complex and difficult to implement.

In view of the above, the Applicant has devised a method, and a corresponding system aimed at preventing power consumption to exceed an available power (so as to avoid at least one or more of system overload, malfunctions, reduced operation, power cut off and potentially extra costs) when a number of household devices are used at the same time.

An aspect of the present disclosure relates to a computer implemented method for managing a plurality of household devices associated with a user. The method may comprise, if an instant power consumption of the plurality of household devices does not comply with a threshold power consumption, providing a plurality of setting scenarios for allowing the instant power consumption of the plurality of household devices to comply with the threshold power consumption. Each setting scenario may correspond to at least one of: (i) one or more settings of each of more than one of the plurality of household devices, and (ii) one or more settings of at least one first household device of the plurality of household devices conditional on a current state of at least one second household device of the plurality of household devices. The method may comprise receiving a user selection of a setting scenario among the plurality of setting scenarios. The method may comprise generating control data for automatically controlling said more than one household device and/or said at least one first household device according to the setting scenario corresponding to the received user selection.

According to an embodiment, said providing a plurality of setting scenarios comprises causing to display, on a user interface, the plurality of setting scenarios.

According to an embodiment, said generating control data is performed in response to a single user input, through the user interface, for said more than one household device and/or said at least one first household device.

According to an embodiment, said single user input comprises said user selection.

According to an embodiment, the instant power consumption complies with the threshold power consumption if the instant power consumption does not exceed the threshold power consumption.

According to an embodiment, the instant power consumption does not comply with the threshold power consumption if the instant power consumption exceeds or is likely to exceed the threshold power consumption.

According to an embodiment, the instant power consumption does not comply with the threshold power consumption if the instant power consumption is lower than the threshold power consumption by an amount equal to or smaller than a predefined amount indicative of a closeness between the instant power consumption and the threshold power consumption. The instant power consumption may comply with the threshold power consumption if the instant power consumption is lower than the threshold power consumption by an amount greater than the predefined amount.

According to an embodiment, the method further comprises causing to provide an indication, for example a visual indication, of the instant power consumption of the plurality of household devices.

According to an embodiment, said visual indication comprises a color.

According to an embodiment, said visual indication depends on the instant power consumption as compared to the threshold power consumption.

According to an embodiment, the user interface comprises one or more user interfaces of at least one household device of the plurality of household devices.

According to an embodiment, the user interface comprises a user interface of a data processing apparatus associated with, or accessible by, a user of the plurality of household devices.

According to an embodiment, the data processing apparatus comprises a mobile device, such as a smartphone, a tablet or a wearable device, or a non-mobile device, such as a laptop/desktop computer.

According to an embodiment, the method further comprises receiving one or more user commands to add one or more household devices to the plurality of household devices and/or to remove one or more household devices from the plurality of household devices.

According to an embodiment, said plurality of household devices comprises supported household devices supporting power consumption measurements. The method may further comprise determining the instant power consumption of the plurality of household devices based on said power consumption measurements.

According to an embodiment, said plurality of household devices comprises unsupported household devices not supporting the power consumption measurements. Said determining the instant power consumption of the plurality of household devices may be based, for each unsupported household device, on a respective power consumption indication or estimate.

According to an embodiment, said power consumption indication or estimate is based on a type of household device.

According to an embodiment, the threshold power consumption is based on an available power being available to the user, or on a fraction of the available power being selected by the user.

Another aspect of the present disclosure relates to a data processing apparatus. The data processing apparatus may comprise at least one processor and a memory storage operatively coupled to the at least one processor and configured to store instructions that, when executed, configure the at least one processor to:
assess whether an instant power consumption of a plurality of household devices complies with a threshold power consumption;
if the instant power consumption does not comply with the threshold power consumption:
   provide a plurality of setting scenarios for allowing the instant power consumption of the plurality of household devices to comply with the threshold power consumption, each setting scenario corresponding to at least one of:
      (i) one or more settings of each of more than one of the plurality of household devices;
      (ii) one or more settings of at least one first household device of the plurality of household devices conditional on a current state of at least one second household device of the plurality of household devices;
   cause to display, on a user interface of the data processing apparatus, the plurality of setting scenarios for user selection;
   receive a selection of a setting scenario among the displayed plurality of setting scenarios;
   generate control data for causing automatic control of said more than one household device and/or said at least one first household device according the setting scenario corresponding to the received user selection, and
   transmit said control data for causing said automatic control.

According to an embodiment, the data processing apparatus comprises a mobile device, such as a smartphone, a tablet or a wearable device, or a non-mobile device, such as a laptop/desktop computer.

Another aspect of the present disclosure relates to a system. The system may comprise the data processing apparatus and a household device. The household device may comprise measuring circuitry configured to measure an instant power consumption of the household device. The household device may comprise communication circuitry configured to communicate the measured instant power consumption to the data processing apparatus and to receive from the data processing apparatus said control data. The household device may comprise control circuitry configured to control an operation of the household device based on the received control data.

A further aspect of the present disclosure relates to a computer program product directly loadable into an internal memory storage of a data processing apparatus. The computer program product may comprise software code means for, when the computer program product is run on the data processing apparatus, configuring at least one processor of the data processing apparatus to:
if the instant power consumption does not comply with the threshold power consumption:
   cause to display on a user interface of the data processing apparatus a plurality of setting scenarios for allowing the instant power consumption of the plurality of household devices to comply with the threshold power consumption, each setting scenario corresponding to at least one of:
      (i) one or more settings of each of more than one of the plurality of household devices;
      (ii) one or more settings of at least one first household device of the plurality of household devices conditional on a current state of at least one second household device of the plurality of household devices;
   receive a user selection of a setting scenario among the plurality of setting scenarios;
   generate control data for causing automatic control of said more than one household device and/or said at least one first household device according to the setting scenario corresponding to the received user selection, and
   cause to transmit said control data for causing said automatic control.

### BRIEF DESCRIPTION OF THE ANNEXED DRAWINGS

These and other features and advantages of the present disclosure will be made apparent by the following description of some exemplary and non-limitative embodiments thereof; for its better intelligibility, the following description should be read referring to the attached drawings, wherein:

FIG. 1 shows a system according to embodiments of the present disclosure;

FIG. 2 shows main components of household devices and of data processing apparatus of the system of FIG. 1, according to embodiments of the present disclosure;

FIG. 3 shows an activity diagram of a method implementing a power management procedure, according to embodiments of the present disclosure, and

FIGS. 4A-4E show exemplary screens displayed on a user device during the power management procedure, according to embodiments of the present disclosure.

### DETAILED DESCRIPTION

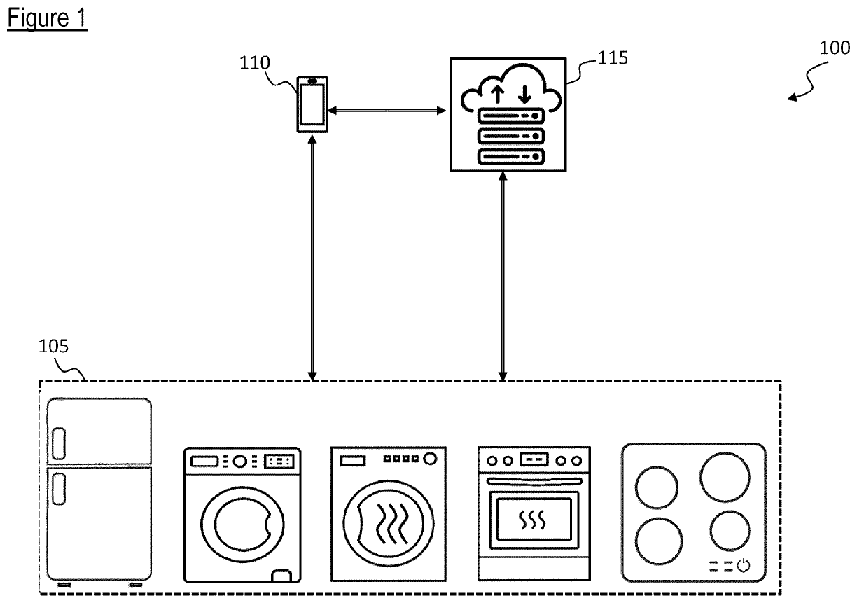

With reference to the drawings, FIG. 1 shows a system 100 according to embodiments of the present disclosure.

In the following, when one or more features of the system (as well as of parts thereof and/or method steps implemented thereby) are introduced by the wording “according to an embodiment”, they are to be construed as features additional or alternative to any features previously introduced, unless otherwise indicated and/or unless there is evident incompatibility among feature combinations.

In the following, the terms “include” and “comprise”, and derivatives thereof, are intended to specify the presence of stated features, integers, steps, operations, elements, and/or components, but do not preclude the presence or addition of one or more other features, integers, steps, operations, elements, components, and/or groups thereof.

According to an embodiment, the system 100 comprises a plurality of household devices 105.

For the purposes of the present disclosure, a household device is a device located or adapted to be located in a home or household environment. Without losing generality, the principles of the present disclosure may also be applied to devices located or adapted to be located outside the household environment.

Just as an example, the household devices 105 may comprise household appliances for home or professional use. Examples of household appliances include, but are not limited to, small appliances (such as microwave ovens, toasters, humidifiers, food processors and coffeemakers) and large appliances (such as freezers, refrigerators, water coolers, ice makers, kitchen stoves, cooking hobs, ovens, washing machines, drying machines, combined washing/drying machines, dishwashers, and air conditioners).

A refrigerator, a washing machine, a drying machine, an oven, and an induction cooking hob are schematically represented (from left to right) in FIG. 1 as examples of household devices 105, although this should not be construed limitatively.

According to an embodiment, the household devices 105 comprise household devices supporting power consumption measurements (hereinafter, supported household devices), i.e., household devices capable of performing (e.g., by their own and/or by cooperation with external measurement devices associated therewith) power consumption measurements.

Without losing generality, for each supported household device the power consumption measurements may comprise measurements about a current or instant power consumption thereof. For the purposes of the present disclosure, a household device capable of performing the power consumption measurements may be a household device for which a power consumption measurement functionality is provided and enabled.

According to an embodiment, the household devices 105 may further comprise household devices not supporting the power consumption measurements (hereinafter, unsupported household devices), i.e., household device incapable of performing or satisfactorily communicating the power consumption measurements. For the purposes of the present disclosure, a household device incapable of performing or satisfactorily communicating the power consumption measurements may be a household device for which no power consumption measurement functionality is provided or for which the power consumption measurement functionality is not enabled and cannot be enabled (e.g., due to factory default settings) and/or a household device by a different manufacturer as the supported device or not connected to a server associated with the manufacturer.

In a practical use case scenario of the present disclosure, discussed in the following, the household devices 105 may comprise both supported household devices and unsupported household devices.

According to an embodiment, the supported household devices 105 (or at least a subset thereof) feature communication or connection capabilities. For the purposes of the present disclosure, the communication or connection capabilities of the supported household devices 105 (or of at least a subset thereof) may allow the supported household devices 105 (or at least a subset thereof) to transmit the power consumption measurements to a data processing apparatus (discussed in the following). According to an embodiment, the communication or connection capabilities of the supported household devices 105 (or of at least a subset thereof) may allow remote control of the supported household devices 105 (or of at least a subset thereof) by the data processing apparatus (as discussed in the following).

Without losing generality, the household devices 105 (regardless they are supported household devices or unsupported household devices) may comprise both household devices featuring communication or connection capabilities (hereinafter, connected household devices), and household devices featuring no communication or connection capabilities (hereinafter, unconnected household devices). Examples of supported and unconnected household devices include household devices having no communication or connection capabilities, but being capable of performing the power consumption measurements and display them on request by the user (for example, through a corresponding item of a menu or submenu of a user interface of the household device).

In a practical use case scenario of the present disclosure, the household devices 105 comprise both connected household devices and unconnected household devices. According to an embodiment, the system 100 comprises a data processing apparatus.

According to an embodiment, the data processing apparatus may comprise a user device 110 and/or a server 115. In the following, the data processing apparatus comprising the user device 110 and/or the server 115 will be concisely denoted by data processing apparatus 110,115, when distinguishing between the user device 110 and the server 115 is not necessary.

For the purposes of the present disclosure, the user device 110 is a personal device (e.g., a personal communication device) associated with a user of the household devices 105. The user may for example be an owner of the household devices 105 and of the user device 110.

According to an embodiment, the user device 110 may comprise a mobile device (e.g., a smartphone, as exemplarily illustrated, a personal digital assistant (PDA), a tablet, or a wearable device, such as a smartwatch), or any electronic device having similar processing and connection capabilities.

According to an embodiment, the user device 110 may comprise a non-mobile device (e.g., a laptop/desktop computer), or any electronic device having similar processing and connection capabilities.

According to an embodiment, the user device 110 and the connected household devices 105 are communicably coupled to each other through respective one or more wireless communication links (such as Wi-Fi communication links, cellular communication links, and/or short-range wireless communication links) and/or wired communication links (such as optical fiber communication links). According to an embodiment, the user device 110 and the connected household devices 105 are communicably coupled to each other via a server, such as the server 115, and the Internet.

Without losing generality, the user device 110 and the connected household devices 105 may be communicably coupled to each other through a Wi-Fi apparatus (such as Wi-Fi modem, a Wi-Fi router, a Wi-Fi gateway, or other wireless access point apparatus, not shown), or without (or without intermediation of) the Wi-Fi apparatus (in which case the user device 110 and the connected household devices 105 may connect to each other through one or more cellular communication links and/or one or more short-range wireless communication links). In a specific example, the household device 105 may connect via the Wi-Fi router to the Internet and the server 115 and then via the server back to the user device 110 (e.g., via the Wi-Fi router or cellular data network such as cellular data network based on 5G cellular technology). During normal operation and control of the household device messages, information and commands exchanged between the user device 110 and the household device 105 may be forwarded, processed and/or translated by the server. Alternatively or additionally, there may be a direct connection between the user device 110 and the household device 105. As an example, the direct connection may be based on Wi-Fi technology. As another example, the direct connection may be realised by a short-range wireless communication technology such as Bluetooth™ technology, Bluetooth™ Low Energy (BLE) technology, ultra-wideband (UWB) technology, NFC technology, RFID technology, Thread™ technology and ZigBee™ technology.

For the purposes of the present disclosure, the server 115 is a server associated with (e.g., held by) a manufacturer of the household devices 105, or a subset thereof. For example, the server 115 may be a server associated with (e.g., held by) a manufacturer of the supported household devices 105. According to an embodiment, the server 135 may comprise one or more servers providing, as a whole, a cloud such as a household device control cloud.

According to an embodiment, the connected household devices (e.g., the supported and connected household devices) 105 and the server 115 are communicably coupled to each other through respective one or more wireless communication links (such as Wi-Fi and/or cellular communication links) and/or wired communication links (such as optical fiber communication links) and the Internet.

Without losing generality, the connected household devices (e.g., the supported and connected household devices) 105 and the server 115 may be communicably coupled to each other through the Wi-Fi apparatus, or without (or without intermediation of) the Wi-Fi apparatus.

According to an embodiment, the connected household devices (e.g., the supported and connected household devices) 105 and the user device 110 may connect to the server 115 via the Internet.

Just as an example, connection between the connected household devices 105 and the server 115 may allow the device manufacturer to deliver one or more services for (or associated with) the connected household devices 105 (such as software/firmware update, and/or information to the user). As a specific example, connection between the connected household devices 105 and the server 115 may allow the connected household devices 105 to be remotely controlled.

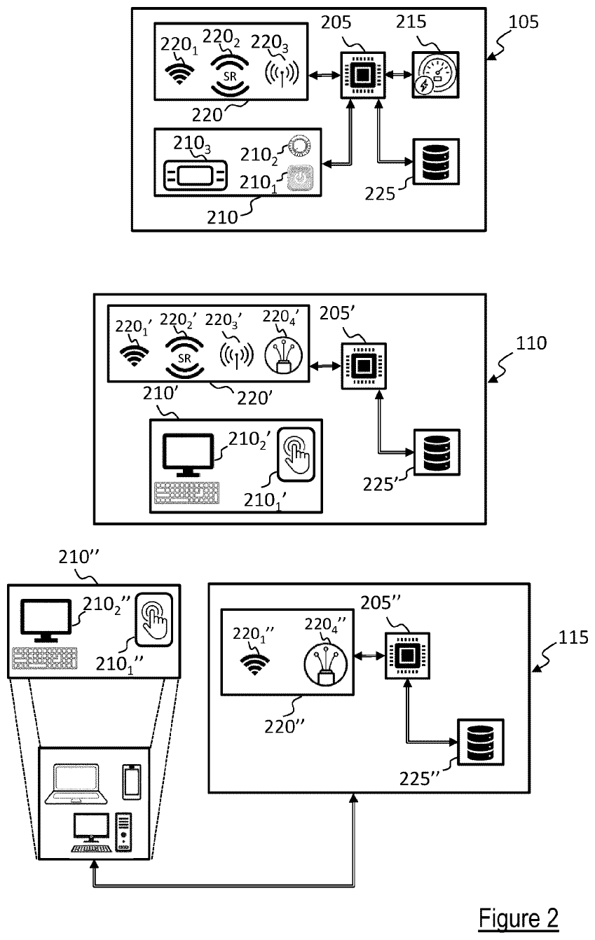

FIG. 2 shows main components of the household devices 105 and of the data processing apparatus 110,115 (i.e., the user device 110 and/or the server 115), according to embodiments of the present disclosure. In the following, only components of the household devices 105 and of the data processing apparatus 110,115 deemed relevant for the understanding of the present disclosure will be discussed for the sake of conciseness.

According to an embodiment, each household device 105 comprises a control unit (or control circuitry) 205 configured to control an operation of the household device 105. Without losing generality, the control unit 205 may comprise one or more processors (such as one or more microcontrollers and/or one or more microprocessors). According to an embodiment, the control unit 205 is configured to control the operation of the household device 105 based on a plurality of functionalities of the household device 105.

For the purposes of the present disclosure, the control unit 205 of each supported and connected household device 105 is configured to control the operation of the supported and connected household device 105 based on control data received from the data processing apparatus 110,115 to allow the instant power consumption of the household devices 105 to comply with a threshold power consumption (as better discussed in the following).

According to an embodiment, each household device 105 (or a subset of the household devices 105) may comprise a user interface 210. Without losing generality, the user interface 210 may comprise, e.g., depending on type and/or model of the household device 105, one or more components among a button or key 2101 (or more thereof), a rotary knob 2102 (or more thereof), and a display 2103 (or more thereof) associated with (e.g., for selecting) corresponding functionalities of the household device 105.

According to an embodiment, the control unit 205 is configured to control the operation of the household device 105 according to instructions received by the user through the respective user interface 210.

According to an embodiment, the control unit 205 and the user interface 210 are communicably coupled to each other (e.g., through a corresponding communication bus).

According to an embodiment, each supported household device 105 comprises a measuring unit (or measuring circuitry) 215. For the purposes of the present disclosure, the measuring unit 215 of each supported household device 105 is configured to measure or determine the instant power consumption of the supported household device 105. Without losing generality, in case of unsupported household device 105, the measuring unit 215 may not be provided, or it may be provided but the unsupported household device may not be capable of, or configured to, communicate the measured or determined instant power consumption of the unsupported household device to the data processing apparatus 110/115.

According to an embodiment, the measuring unit 215 (when provided) may be a physical entity separate from the control unit 205 (as exemplary illustrated). In this embodiment, the control unit 205 and the measuring unit 215 may for example be communicably coupled to each other through a corresponding communication bus.

According to an embodiment, the measuring unit 215 (when provided) may be part of the control unit 205 as a dedicated measuring functionality thereof.

According to an embodiment, the measuring unit 215 (when provided) may be an external measurement device being external to the household device 105.

According to an embodiment, each connected household device 105 comprises a communication unit (or communication circuitry) 220. For the purposes of the present disclosure, the communication unit 220 of each supported and connected household device 105 is configured to communicate the respective instant power consumption to the data processing apparatus 110,115 and to receive the control data from the data processing apparatus 110,115.

Without losing generality, the communication unit 220 may comprise a wireless (or Wi-Fi) communication unit 2201. The Wi-Fi communication unit 2201 may be configured to allow connection of the household device 105 to a wireless communication network (hereinafter concisely referred to as Wi-Fi network). An example of Wi-Fi network includes, but is not limited to, a wireless local area network (WLAN). Without losing generality, the Wi-Fi network may implement a connected or smart environment allowing client devices (such as one or more of the household devices 105 and the user device 110) connected to the Wi-Fi network to connect to each other (e.g., so as to become part of the smart environment) and/or to an external communication network (such as the Internet network).

According to an embodiment, the communication unit 220 may comprise a short-range (or SR) communication unit 2202. The SR communication unit 2202 may be configured to exchange (i.e., transmit and receive) data over one or more short-range wireless communication channels. Without losing generality, the SR communication unit 2202 may be based on one or more among Bluetooth™M technology, Bluetooth™ Low Energy (BLE) technology, ultra-wideband (UWB) technology, NFC technology, RFID technology, Thread™ and ZigBee™ technology. According to an embodiment, the communication unit 220 may comprise a cellular communication unit 2203. The cellular communication unit 2203 may be configured to exchange (i.e., transmit and receive) data over one or more cellular communication channels. Without losing generality, the cellular communication unit 2203 may be based on one or more among 3G, 4G, LTE/LTE Advanced, and/or 5G cellular technologies.

According to an embodiment, the control unit 205 and the communication unit 220 are communicably coupled to each other (e.g., through a corresponding communication bus).

According to an embodiment, each household device 105 comprises a memory storage 225.

According to an embodiment, the memory storage 225 comprises a non-volatile memory (e.g., a ROM memory) for storing basic code for a bootstrap of the household device 105.

According to an embodiment, the memory storage 225 comprises a volatile memory (e.g., a RAM memory) used as a working memory by the control unit 205. According to an embodiment, the memory storage 225 comprises a mass-memory for storing programs and data.

According to an embodiment, the control unit 205 and the memory storage 225 are communicably coupled to each other (e.g., through a corresponding communication bus).

According to an embodiment, the data processing apparatus 110,115 comprises a control unit 205′,205″ configured to control an operation of the data processing apparatus 110,115.

For the purposes of the present disclosure, the control unit 205′,205″ is configured to provide a plurality of setting scenarios for allowing the instant power consumption of the household devices 105 to comply with the threshold power consumption, and to generate the control data corresponding to a selected setting scenario being selected by the user (as better discussed in the following).

According to an embodiment, the data processing apparatus 110,115 comprises a user interface 210′,210″.

According to an embodiment, the user interface 210′ of the user device 110 may for example comprise a touch-sensitive display 2101′ of a mobile device or a monitor/keyboard system 2102′ of a non-mobile device.

According to an embodiment, the user interface 210″ of the server 115 may for example comprise a user interface of a client device communicably coupled to the server 115. Without losing generality, the client device may comprise a mobile device (such as a smartphone, as illustrated, a tablet or a wearable device) or a non-mobile device (such as a laptop computer or a desktop computer, as illustrated), and the user interface 210″ may for example comprise a touch-sensitive display 2101″ of a mobile device or a monitor/keyboard system 2102″ of a non-mobile device.

According to an embodiment, the control unit 205′,205″ is configured to control the operation of the data processing apparatus 110,115 according to instructions received by the user through the respective user interface 210′,210″.

According to an embodiment, the data processing apparatus 110,115 comprises a communication unit (or communication circuitry) 220′,220″. For the purposes of the present disclosure, the communication unit 220′,220″ of the data processing apparatus 110,115 is configured to receive the instant power consumptions from the supported and connected household devices 105 and to transmit the control data corresponding to the selected setting scenario.

According to an embodiment, in case that the data processing apparatus 110,115 comprises a mobile device, the communication unit 220′may for example comprise a Wi-Fi communication unit 2201′, a SR communication unit 2202′, and/or a cellular communication unit 2203′.

For the purposes of the present disclosure, features, alternatives and combinations thereof discussed above in connection with the communication unit 220 (and, particularly, the Wi-Fi communication unit 2201, the SR communication unit 2202, and the cellular communication unit 2203) equivalently apply to the communication unit 220′ (and, particularly, to the Wi-Fi communication unit 2201′, the SR communication unit 2202′, and the cellular communication unit 2203′).

According to an embodiment, in case that the data processing apparatus 110,115 comprises a non-mobile device, the communication unit 220′ may for example comprise, additionally or alternatively to the Wi-Fi communication unit 2201′, the SR communication unit 2202′, and/or the cellular communication unit 2203′, a wired communication arrangement 2204′ for implementing the wired communication links (such as optical fiber communication links).

According to an embodiment, the communication unit 220″ of the server 110 may for example comprise a Wi-Fi communication unit 2201″ and/or a wired communication arrangement 2204″ for implementing wired communication links (such as optical fiber communication links).

For the purposes of the present disclosure, features, alternatives and combinations thereof discussed above in connection with the communication unit 220′ (and, particularly, the Wi-Fi communication unit 2201′and the wired communication arrangement 2204′) equivalently apply to the communication unit 220″ (and, particularly, to the Wi-Fi communication unit 2201″ and the wired communication arrangement 2204″).

According to an embodiment, the control unit 205 and the communication unit 220′,220″ are communicably coupled to each other (e.g., through a corresponding communication bus).

According to an embodiment, the data processing apparatus 110,115 comprises a memory module 225′,225″. Similarly to the memory module 225 of the household device 105, the memory module 225′,225″ of the data processing apparatus 110,115 may include, but is not limited to, one or more among a ROM memory (e.g., for storing basic code for a bootstrap of the data processing apparatus 110,115), a RAM memory (e.g., used as a working memory by the control unit 205′,205″), and a mass-memory (e.g., for storing programs and data). Without losing generality, the mass memory of the memory module 225″ of the server 115 may comprise one or more databases for storing data.

According to an embodiment, the control unit 205′,205″ and the memory storage 225′,225″ are communicably coupled to each other (e.g., through a corresponding communication bus).

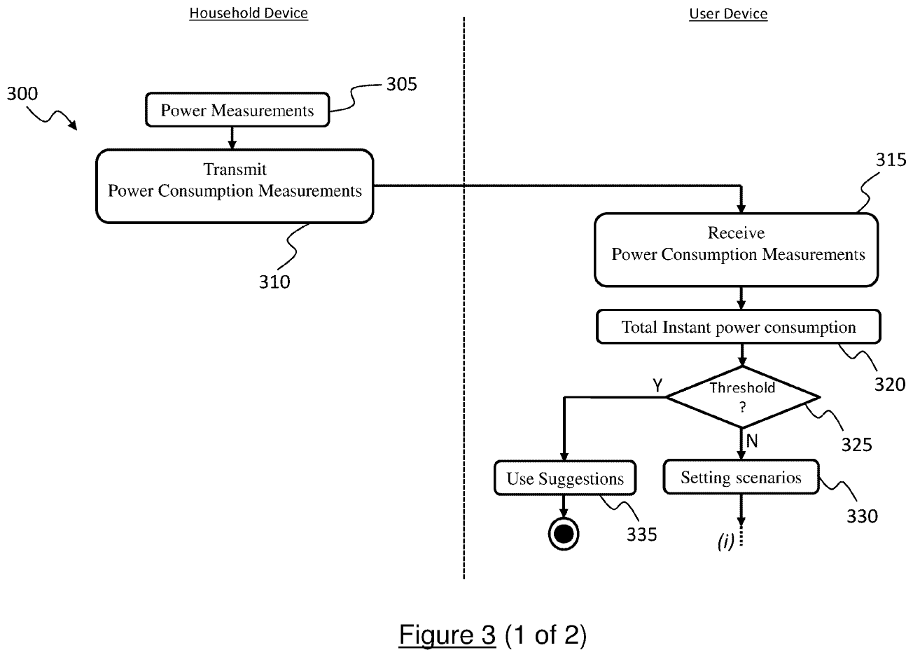

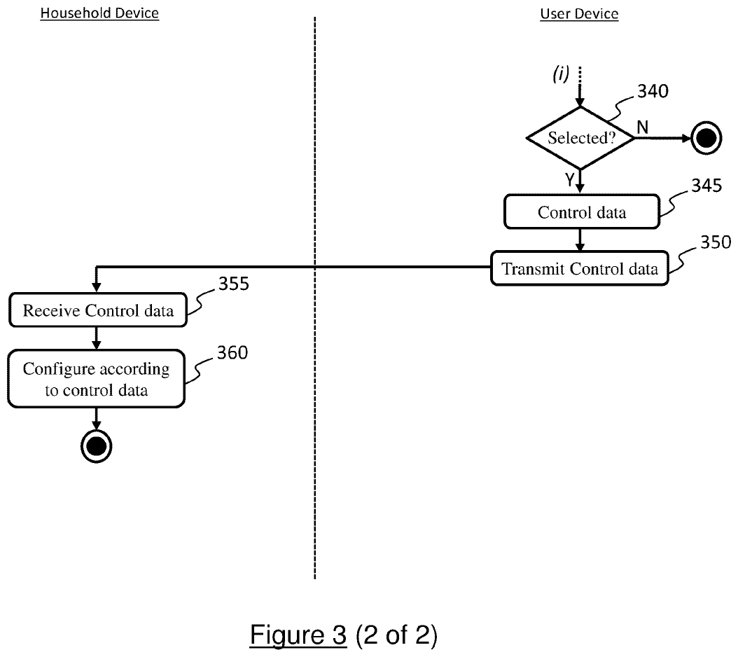

With reference now to FIG. 3, it shows an activity diagram of a method 300 implementing a power management procedure, according to embodiments of the present disclosure. Particularly, FIG. 3 shows a swim-lane activity diagram which describes the flow of activities relating to exemplary embodiments of the present disclosure. In this respect, each node of the activity diagram may correspond to one or more executable instructions for implementing the specified logical function on a relevant software component of a respective actor (i.e., the household device or the data processing apparatus).

In the following, the method steps at the household device side are intended to be performed by supported and connected household devices.

In the following, the exemplary scenario will be discussed in which the method steps at the data processing apparatus side are performed exclusively (or substantially exclusively) by the user device 110. However, as progressively detailed while discussing the power management procedure, embodiments may be provided in which some of the method steps at the data processing apparatus side, shown in FIG. 3, may be performed by the server 115 (hereinafter, cooperative embodiments). Moreover, embodiments may be provided in which the method steps at the data processing apparatus side are performed exclusively (or substantially exclusively) by the server 115. Moreover, in order to carry out some of the steps, the user device may need assistance from the server and/or the server may need assistance from the user device.

According to an embodiment, the method steps performed by the household device 105 and by the data processing apparatus 110,115 may be implemented by respective computer program products loadable into an internal memory of the household device 105 (such as the memory module 225) and of the data processing apparatus 110,115 (such as the memory module 225′,225″). It will be appreciated that the steps of the data processing apparatus 110, 115 carried out by the user device 110 will be stored in internal memory of the user device 110 and the steps of the data processing apparatus 115 carried out by the server 115 will be stored in internal memory of the server 115. According to an embodiment, each computer program product comprises software code means for configuring the respective control unit 205,205′,205″ (e.g., one or more respective processors) to perform the method steps when the computer program product is run on the household device 105 and on the data processing apparatus 110,115.

By computer program product loadable into an internal memory of an apparatus (such as the household device 105 and/or the data processing apparatus 110,115), it is herein meant that the computer program can be introduced into the internal memory of the relevant apparatus so as to achieve an apparatus programmed to be capable of, or adapted to, carrying out the corresponding method steps.

Without losing generality, the computer program product implementing the method steps performed by the household device 105 may comprise, or be included in, a firmware of the household device 105, the firmware being for example stored in a memory location of the control unit 205.

Without losing generality, the computer program product implementing the method steps performed by the user device 110 may comprise, or be included in, a software application downloadable and installable on the user device 110. In the exemplary considered case in which the user device 110 comprises a mobile device, the software application may comprises a mobile application downloaded or downloadable from a digital distribution platform associated with the operating system of the mobile device (or from the server 115), and installed or installable on the mobile device (the mobile application being for example stored or storable in a memory location of the control unit 205′). Without losing generality, installation of the mobile application (or, more generally, of the software application) on the mobile device (or, more generally, on the user device 110) also provides for a log-in by the user with a corresponding registered account (so as to provide an initial user authentication).

Without losing generality, the computer program product implementing the method steps performed by the server 115 may comprise, or be included in, a firmware of the server 115, the firmware being for example stored in a memory location of the control unit 205″.

In the following, the method 300 will be discussed by making reference to the exemplary use case in which the household devices 105 comprise a refrigerator, a washing machine, a drying machine, an oven, and an induction cooking hob, and in which the washing machine, the drying machine, the oven, and the induction cooking hob are supported and connected household devices, and the refrigerator is an unsupported (and unconnected) household device.

In the following, the household devices 105 are assumed to be registered (e.g., linked with a user or user device) in, for example, a database of the server and visible and/or controllable using the mobile application. Without losing generality, at any phase of the power management procedure and/or at any configuration phase (such as initial or non-initial configuration phase) of the mobile application, one or more household devices may be added to the registered household devices (e.g., through respective one or more user commands available at the mobile application) and/or on one or more household devices may be removed from the registered household devices (e.g., through respective one or more user commands available at the mobile application).

Broadly speaking, the method 300 comprises, if the instant power consumption of the household devices 105 (i.e., a total instant power consumption associated with the plurality of household devices) does not comply with a threshold power consumption, providing a plurality of setting scenarios for allowing the total instant power consumption to comply with the threshold power consumption, and generating control data for automatically controlling one or more of the household devices according to a setting scenario being selected by a user. Thus, according to an exemplary practical implementation, the method 300 implements a power management procedure aimed at preventing the power consumption to exceed an available power (so as to avoid system overload, appliance malfunctioning, extra costs to be paid or power cut off) when a number of household devices are used at the same time.

In the following discussion of the activity diagram, the term “upon” is intended to broadly mean “in response to”, without any strict temporal significance linked to the event to which the term refers.

According to an embodiment, the method 300 comprises, at each supported household device 105 performing the power consumption measurements (action node 305). According to an embodiment, the performance of the power consumption measurement may happen on demand from user device 110. For example, if the method steps of the user device described here are implemented in a software application on the user device, the software application may ask all connected household devices for an instant power consumption. It may do this at regular intervals and/or upon the occurrence of specific events. If a household device is off, the instant power will be 0. In other implementations, the user device or software application may only ask household devices for which an operation program (such as cooking program or a laundry treatment program) is in progress, to perform a power measurement. Still further, the measurements may be obtained independently by the household devices at regular intervals, and/or on occurrence of specific events, and reported to the server. They can then be retrieved by the user device or software application when needed. The events could include, but are not limited to, the household device turning on, an operating program of the household device starting or settings of the household device being changed.

Without losing generality, the power consumption measurement functionality of each supported household device may be enabled by default and be automatically implemented at a power on of the household device (e.g., from a start of the respective operation program), or it may be manually enabled (e.g., by the user), for example by selecting a corresponding button or key, or a corresponding item of a menu or submenu of a user interface (if provided) of the supported household device.

According to an embodiment, the method 300 comprises, at each supported and connected household device 105, transmitting the respective power consumption measurements to the data processing apparatus, such as the user device 110 (action node 310).

Without losing generality, transmission of the power consumption measurements may be based on Wi-Fi communication links, SR communication links and/or cellular communication links.

In a specific example, the power consumption measurements are transmitted to the server 115 which forwards the measurement to the user device 110. Without losing generality, the power consumption measurements may be transmitted via the server 115 using one or more of the mentioned communication links and the Internet.

Alternatively, the power consumption measurements may be transmitted directly to the user device 100. Without losing generality, when the information is transmitted over a direct connection, pairing or signalling aimed at establishing a trusted communication link between the household device 105 and the user device 110 may preliminarily take place. Without losing generality, each household device 105 and the user device 110 may exchange messages (for example, related to encryption and/or authorization) to establish secure communication.

According to an embodiment, the transmission of the power consumption measurements by the household device 105 may take place periodically, for example on a time interval basis. Without losing generality, the time interval is sufficiently short in time that the measured power consumptions may be regarded as instant power consumptions. Without losing generality, the time interval may depend on the type of household device; for example, longer time intervals may be envisaged for household devices for which low variations in the power consumptions may be expected in the short run (such as a refrigerator), and shorter time intervals may be envisaged for household devices for which high variations in the power consumptions may expected in the short run (such as a washing machine or an induction cooking hob). Just as a numerical example, the time interval may be of the order of 3-30 seconds.

According to an embodiment, the transmission of the power consumption measurements by the household device 105 may take place aperiodically, for example at each variation in the power consumption that exceeds a predefined threshold.

As mentioned above, the power consumption measurements may be requested by the user device 110. The user device 110 may request the power consumption measurements upon opening of the software application and then at regular intervals and/or at the occurrence of specific events. Alternatively, the power consumption measurements may be obtained by the household devices 105 at specific times or time intervals independently of the user device, transmitted and stored at the server 115 and only forwarded/pushed to the user device 110 if the software application on the user device is executing and the user has logged in. Just as an example, when the user opens the software application, the last power consumption measurements for each household device 105 may be sent to the user device 110. For example, the server 115 may comprise or be linked to a MQTT broker, or any other known Internet-of-Things (IoT) messaging protocol broker, which forwards the power consumption measurements to the user device 110 at a suitable time.

According to an embodiment, the method 300 comprises transmitting, e.g., together with the power consumption measurements, identification information for univocally identifying the household device 105 which the power consumption measurements refer to.

According to an embodiment, the identification information comprises one or more information among type, model name, model number, and serial number of the household device 105. According to an embodiment, the identification information is stored in the memory module 225 or in a proper memory location of the control unit 205 of the household device 105.

According to an embodiment, not shown, the identification of the household device 105 based on the received identification information may be supported or assisted (at least partially) by the server 115 (for example, by communication between the server 115 and the user device 110). In one specific example, the server 115 will identify the power consumption measurements of all household devices linked to a user and push those power consumption measurements to the software application of the user device 110 associated with the user.

If the power consumption measurements are carried out on demand by the user device 110, the power consumption measurements may, additionally or alternatively, be transmitted with an identifier identifying a message, from the user device, in response to which the power consumption measurements were performed.

In yet another implementation, the power consumption measurements may be transmitted to the server 115 through the user device 110 (i.e., with the user device 110 that, upon reception of the power consumption measurements, retransmit them to the server 115).

Without losing generality, in case of supported and unconnected household devices, the respective power consumption measurements may be manually input to the user device 110 by the user.

According to an embodiment, the method 300 comprises, at the user device 110, receiving the power consumption measurements (action node 315). According to an embodiment, and as indicated above, reception of the power consumption measurements may take place upon opening of the mobile application on the user device 110. For the purposes of the present disclosure, by mobile application opening is herein meant that the mobile application is (automatically or manually) launched, and a corresponding mobile application environment the user can see and interact with, is displayed. As mentioned above, in a specific example, the opening of the software application may trigger stored power consumption measurements to be pushed to the user device 110 from the server 115. In another specific example, the mobile application may request power consumption measurements from all connected household devices, associated for example with the user of the user device 110 on which the mobile application is running, upon launch of the mobile application. Of course, other implementations may be used. For example, according to another embodiment, a first reception of the power consumption measurements (from any household device) may trigger the opening of the software application on the user device 110. According to yet another embodiment, the first reception of the power consumption measurements may trigger a running of the software application on the user device 110 in background (i.e., without that the user can immediately notice and interact with it), so as to allow subsequent receptions of the power consumption measurements (and subsequent processing aimed at determining the total instant power consumption) without annoying the user. Subsequent power consumption measurements may be received by the user device 110 as and when they are performed. According to an embodiment, the method 300 comprises determining the total instant power consumption, i.e., the instant power consumption of the household devices 105 (action node 320).

According to an embodiment, the total instant power consumption is determined based on the power consumption measurements of each supported household device.

According to an embodiment, the total instant power consumption is determined, at each time instant, based on the power consumption measurements (received from the supported household devices) that are available at that time instant (i.e., the latest power consumption measurements).

According to an embodiment, the total instant power consumption is based on a power consumption indication or estimate of each unsupported household device. Without losing generality, for each unsupported household device, the respective power consumption indication or estimate may be input by the user (for example, based on an energy label associated with the household device and made available by a household device manufacturer). Without losing generality, for each unsupported household device, the respective power consumption indication or estimate may be based on a type of household device: just as an example, the user may be allowed to input the type of household device (or other identification information), and the corresponding power consumption indication or estimate may be determined or retrieved by the user device 110. Just as an example, the power consumption indication or estimate may be locally stored in the user device 110, for example together with data associated with the mobile application. Just as another example, the power consumption indication or estimate may be remotely stored in, and retrieved from, the server 115 (or other entity external to, and connectable with, the user device 110 or the server 115).

As should be understood, the possibility of using power consumption indications or estimates for unsupported household devices is particularly (although not exclusively) advantageous for always-on unsupported household devices, i.e. unsupported household devices that are always (or substantially always) switched on (such as refrigerators), and for which the respective power consumption indications or estimates may be considered as constant values with a good approximation.

Without losing generality, for each unsupported household device (in the example at issue, a refrigerator), the user may be allowed to input the respective power consumption indication or estimate or the type of household device (or other identification information) at any phase of the power management procedure and/or at a configuration phase of the mobile application.

According to an embodiment, the method 300 comprises assessing whether the total instant power consumption complies with the threshold power consumption (decision node 325).

According to an embodiment, the threshold power consumption is based on an available power being available to the user (the available power depending for example on user's contract demand or committed power capacity). According to an embodiment, the threshold power consumption may be based on a fraction of the available power. According to an embodiment, the fraction of the available power may be based on a guard or safety margin (for example, a predefined or user-defined percentage of the available power, such as 10% to 20% of the available power), e.g., so as to avoid power interruptions even in the presence of instantaneous absorption peaks. According to an embodiment, the available power and/or the fraction of the available power is selected by the user (e.g., through a proper setting of the mobile application). Alternatively, the available power and/or the fraction of the available power may be hard-coded in the software application or set by the server 115.

According to an embodiment, the total instant power consumption complies with the threshold power consumption if the total instant power consumption does not exceed the threshold power consumption. In this embodiment, assuming for example an available power of 6 KW and a threshold power consumption of 5.4 KW (i.e., the 10% of the available power), the total instant power consumption complies with the threshold power consumption if the total instant power consumption does not exceed 5.4 KW.

According to an embodiment, the total instant power consumption does not comply with the threshold power consumption if the total instant power consumption exceeds or is likely to exceed the threshold power consumption. Without losing generality, the user device 110 may determine that the total instant power consumption is likely to exceed the threshold power consumption based on historical power consumption measurements and/or forecasting algorithms (such as machine learning based forecasting algorithms) and/or statistical models (e.g., taking into account parameters including, but not limited to, seasonality, cyclic behaviors and user habits). Just as an example, assuming for example an available power of 6 KW, and assuming for example that the total instant power consumption is 3.5 KW at dinner time (with the induction cooking hob not yet in use), the user device 110 may determine that the total instant power consumption is likely to exceed the threshold power consumption based on the fact that, typically, the induction cooking hob is used at dinner time with an average power consumption of 3.5 KW.

According to an embodiment, the total instant power consumption does not comply with the threshold power consumption if the total instant power consumption is lower than the threshold power consumption by an amount equal to or smaller than a predefined amount indicative of a closeness between the total instant power consumption and the threshold power consumption, and the total instant power consumption complies with the threshold power consumption if the total instant power consumption is lower than the threshold power consumption by an amount greater than the predefined amount.

According to an embodiment, the predefined amount may be set by the user, for example through corresponding settings of the mobile application. Alternatively, the predefined amount may be hard-coded in the software application or set by the server 115.

As an example, assuming for example an available power of 6 KW, a threshold power consumption of 5.4 KW, and predefined amount of 500 W, a total instant power consumption of 5 KW does not comply with the threshold power consumption, and a total instant power consumption of 4.8 KW complies with the threshold power consumption.

According to an embodiment, the predefined amount may be based on the power consumption indications or estimates of the unsupported household devices: in this embodiment, the power consumption indications or estimates may provide no additive contribution to the total instant power consumption (i.e., with the total instant power consumption that, in this embodiment, is based only on the power consumption measurements), and are instead taken into account as a tolerance on the threshold power consumption.

According to an e embodiment, the method 300 comprises, if the total instant power consumption does not comply with the threshold power consumption (exit branch N of the decision node 325), providing a plurality of setting scenarios for allowing the total instant power consumption to comply with the threshold power consumption (action node 330).

According to a first implementation, each setting scenario may correspond to one or more settings of each of two or more household devices 105. Just as an example, the setting scenario may be aimed at distributing an available power among the household devices depending on a user profile. Just as another example, the setting scenario may be aimed at allocating power among the household devices to prioritize operation of kitchen household devices (for example, oven, induction hob) with respect to other household devices (such as washing machines and drying machines, the operation of which may be paused or delayed).

According to a second implementation, each setting scenario may correspond to one or more settings of a first household device (or more thereof) among the household devices 105 conditional on a current state of a second household device (or more thereof) among the household devices 105. Just as an example, when both the oven and the induction cooking hob are operating together to prepare a meal, a setting scenario may be aimed at limiting a power level of one or more cooking zones of the induction cooking hob to a certain power level while the oven is heating up, thus allocating more power to the oven at the initial phases of the oven operation (e.g., so as to take into account the power absorption profile of the oven).

One or more of the plurality of setting scenarios may be provided according to the first implementation and one or more alternative setting scenarios of the plurality of setting scenarios may be provided according to the second implementation. One or more setting scenarios may be provided according to both the first and second implementations.

Without losing generality, in both the first and second implementations, the settings of each setting scenario may comprise parameter settings (including, but not limited to, power settings, time settings, and temperature settings) and/or operative settings (including, but not limited to, stop and/or delay of an operation or an operation phase of one or more household devices).

Providing the setting scenarios may comprise generating the setting scenarios. According to an embodiment, the generation of the setting scenarios may be based on a proper maximization criterion aimed at maximizing a power consumption saving. In the implementation described with respect to FIG. 3 with nodes 315 to 335 taking place in the user device 110, the user device generates the setting scenarios. However, in other implementations the server 115 may generate the setting scenarios. In other words, at least part of providing the setting scenarios could take place in the server 115

Providing the setting scenarios may additionally or alternative comprise causing to display the setting scenarios on a user interface. The user device 110 may both generate and cause to display the setting scenarios. Alternatively, the user device 110 may receive the setting scenarios from the server 115 and cause to display the received setting scenarios. Without losing generality, when referring to the operations of the user device, said providing the setting scenarios may comprise causing to display the setting scenarios on the user interface 210′of the user device 110. The setting scenarios may be displayed according to a proper ordering criterion, e.g., from a most recommended setting scenario to a least recommended setting scenario. Just as an example, the most recommended setting scenario may be associated with a higher power consumption saving and the least recommended setting scenario may be associated with a lower power consumption saving.

According to an embodiment, the generation of the setting scenarios may trigger a corresponding notification on the user device 110. The notification may for example indicate that setting scenarios have been generated and are available to be examined by the user. The notification may for example be a push notification, such as a banner on the top of the device screen and/or dialog box that interrupts and blocks the view of any running application, and may contain text and/or vocal and/or image message (possibly with the further playing of an alert sound to attract the attention of the user). According to an embodiment, selection of the notification by the user may decree the opening of the mobile application. According to an embodiment, the user may confirm or deny the opening of the mobile application. Just as an example, the opening of the mobile application may be achieved by touching on the notification or by means of other gesture (for example, by means of a sliding on the notification box). According to an embodiment, upon mobile application opening, the setting scenarios are displayed.

In alternative embodiments, said providing the setting scenarios comprises causing to display the setting scenarios on one or more user interfaces of one or more household devices among the household devices 105. Just as an example, the setting scenarios may be displayed on a display of the washing machine and/or on a display of the drying machine.

According to an embodiment, the setting scenarios may be generated on request by the user. In this embodiment, the user may open the mobile application on his/her own initiative (i.e., without previous notification from the mobile application), check the total instant power consumption and requesting (e.g., through a proper function of the mobile application) the generation of setting scenarios aimed at reducing the total instant power consumption (for example, at least by an amount or percentage defined by the user).

According to an embodiment, the method 300 may further comprise causing to provide an indication of the total instant power consumption (and/or of an instant power consumption of each supported household device currently in use).

According to an embodiment, the indication of the total instant power consumption comprises a visual indication, for example a color (or more colors). According to an embodiment, the visual indication depends on the total instant power consumption as compared to the threshold power consumption.

Without losing generality, the visual indication may comprise a bar, an area graph or other graphical representation of the total instant power consumption, with the bar, area graph or other graphical representation that may exhibit a different color depending on the total instant power consumption with respect to the threshold power consumption Just as an example, a red color may be shown if the total instant power consumption is close to the threshold power consumption, a green color may be shown if the total instant power consumption is far from the threshold power consumption, or an orange color may be shown for intermediate values of the total instant power consumption.

According to an embodiment, the indication of the total instant power consumption may be provided contextually to the generation of the setting scenarios. In this embodiment, the indication of the total instant power consumption may be displayed together with the setting scenarios upon opening of the mobile application.

According to an embodiment, the indication of the total instant power consumption may be provided contextually to the notification indicating that setting scenarios have been generated and are available to be examined by the user.

According to an embodiment, the indication of the total instant power consumption may be provided as the notification to be selected by the user to open the mobile application.

According to an embodiment, the method 300 comprises, at the user device 110, upon generation of the setting scenarios, allowing user selection of a setting scenario (decision node 340).

Without losing generality, user selection may be supported or guided or assisted by corresponding on-screen instructions, as progressively discussed here below.

Just as an example of on-screen instructions supporting or guiding or assisting the user selection, the user device 110 may display a list of setting scenarios on the corresponding screen, e.g., together with detailed information about the parameter settings and/or operative settings corresponding to each setting scenario, and, upon user selection of a setting scenario, open a dialog box to allow the user to confirm selection or deny selection.

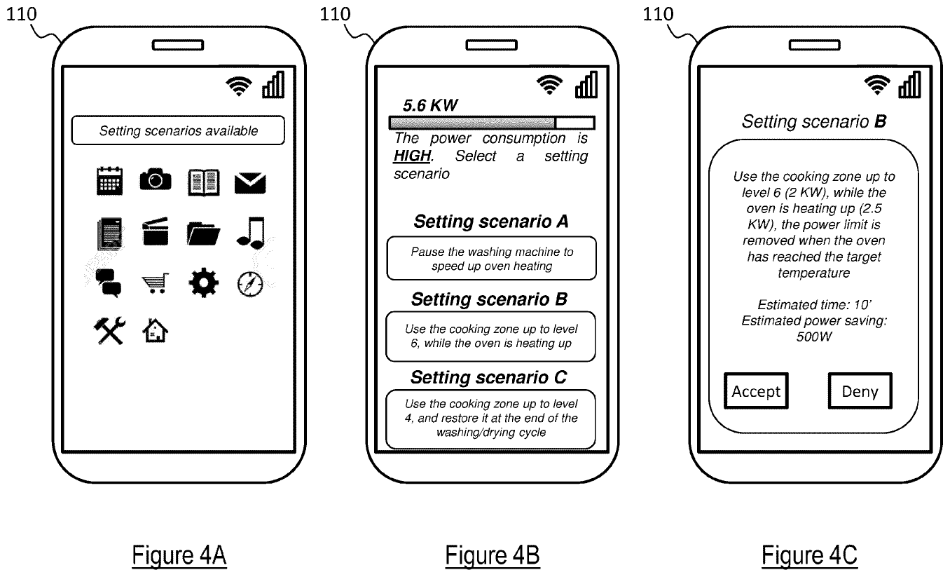

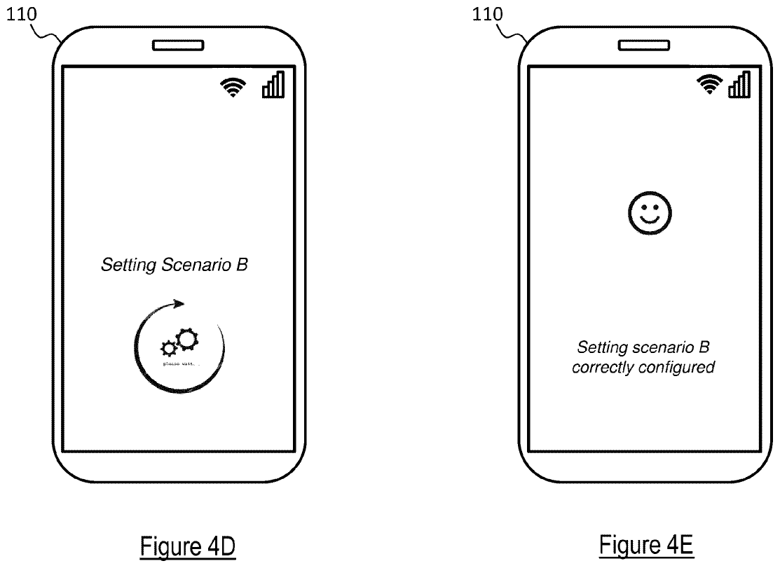

Just as another example of on-screen instructions supporting or guiding or assisting the user selection, the user device 110 may display the list of setting scenarios on the corresponding screen (for example, together with basic information about involved household devices and/or power consumption saving associated with each setting scenario), and, in response to selection by the user of a setting scenario, display the detailed information about the parameter settings and/or operative settings corresponding to the selected setting scenario and open a dialog box to allow the user to confirm selection (which may decree generation of corresponding control data, as discussed here below) or deny selection (which may cause the user device 110 to return to displaying the list of setting scenarios). Exemplary screens that may be displayed on the user device UD in this use-case are illustrated in FIGS. 4A-4E (discussed in the following).

According to an embodiment, the providing of the setting scenarios for allowing the total instant power consumption to comply with the threshold power consumption (action node 330) may further comprise prompting the user to perform setting scenario selection.

According to an embodiment, the prompting of the user to perform setting scenario selection comprises textual and/or vocal and/or image indications or instructions.

According to an embodiment, the prompting of the user to perform the setting scenario selection comprises prompting the user to perform the setting scenario selection within a prescribed time limit. Just as an example, a warning indication or memo may be provided to warn the user to perform the setting scenario selection within the prescribed time limit. The warning indication or memo may include a timer or a countdown. It may be provided with optical and/or acoustical indication for drawing the attention of the user. Just as an example, the optical indication may comprise a blinking light, and the acoustical indication may comprise emission of a beep sound. According to an embodiment, the optical and/or acoustical indication for drawing the attention of the user may change (e.g., increase, reduce, or vary an intermittency frequency) the closer the prescribed time limit gets.

The prompting of the user to perform the setting scenario selection within the prescribed time limit may allow avoiding that a belatedly selected setting scenario does not reflect a current state of the household devices any longer (for example, in that one or more household devices may meanwhile have ended their operation cycles, or in that a user, on his/her own initiative, may meanwhile have switched off one or more household devices or changed parameters thereof).

Back to the activity diagram, according to an embodiment the method 300 comprises, if the total instant power consumption complies with the threshold power consumption (exit branch Y of the decision node 325), providing tips or advice about possible uses of the household devices 105 while keeping the total instant power consumption still complying with the threshold power consumption (action node 335). For example, the tips or advice may relate to possible household devices and/or possible parameter settings thereof that can be used to exploit a current power availability (the current power availability being computed, for example, as the difference between a maximum available power, e.g., the user's contract demand or committed power capacity, and the total instant power consumption). Just as a practical example, assuming that the induction cooking hob is the only household device in use, and that the corresponding instant power consumption (which, in this case, also corresponds to the total instant power consumption) is 3 KW below the threshold power consumption (3 KW being therefore the current power availability), an exemplary tip or advice may be “you have enough power to switch on the oven at 220° C. together with your induction cooking hob right now”.

According to an embodiment, the method 300 ends if, at the user device 110, no user selection is performed or if no user selection is performed within the prescribed time limit (exit branch N of decision node 340).

Although nodes 315 to 330 have been described to be carried out at the user device 110 in FIG. 3, in cooperative embodiments, some or all of the operations may be carried out at the server 115 or be shared between the user device 110 and the server 115. The server 115 could receive the power consumption measurements and calculate the total instant power consumption. The server 115 could then send information indicative of the determined total power consumption to the user device 110. The user device 110 could determine the total power consumption (action node 320) from the received information and then proceed to carry out the relevant operations out of nodes 325, 330 and 335. Alternatively, the server 115 could further assess whether the instant power consumption complies with a threshold power consumption by comparing the total power consumption to the threshold power consumption (action node 325) and send the outcome of the comparison to the user device 110 or only inform the user device if the total power consumption does not comply with the threshold power consumption. The user device 110 would then assess whether the instant power consumption complies with the threshold power consumption based on the received information from the server and proceed with node 330 or 335 based on the assessment. Still further, the server 115 could further generate the setting scenarios (action node 330) if the power consumption does not comply with the threshold power consumption and send the generated setting scenarios to the user device 110 to cause the user device to provide the setting scenarios on the user interface.

According to an embodiment, the method 300 comprises, at the user device 110, in response to user selection (exit branch Y of decision node 340), generating control data for automatically controlling the household devices 105 (or at least a subset thereof, hereinafter referred to as involved household devices) according to the selected setting scenario (action node 345). By involved household device is herein meant a household device that, based on the control data, has one or more parameter settings and/or one or more operative settings to be set according to the selected setting scenario. Thus, considering for example the household devices 105 of FIG. 1, the washing machine may be not an involved household device if the selected scenario provides for allowing the washing machine to end an ongoing washing cycle without any parameter and/or operative setting changes.

Automatic control of the involved household devices avoids that the user has to navigate to the individual user interfaces of the involved household devices to implement the setting scenario.

According to an embodiment, control data generation is performed in response to a single user input, through the user interface, for all of the involved household devices. In other words, a separate user input may not be carried out for each involved household device.

According to an embodiment, the single user input comprises the user selection of the setting scenario. Thus, a simple and quick power management can be achieved.

According to an embodiment, the method 300 comprises transmitting, to each involved household device 105, the control data for automatic control thereof (action node 350). Without losing generality, transmission of the control data may be based on Wi-Fi communication links, SR communication links and/or cellular communication links. Without losing generality, the control data may be transmitted to each involved household device (i.e., to each household device for which one or more parameter settings and/or one or more operative settings are to be set according to the selected setting scenario. The control data may be transmitted via the server 115. The control data may be transmitted to the server 115 which processes and/or translates the control data into new control data, comprising commands, which is then sent to the respective household devices. For example, if the selected scenario comprises applying a setting for a first household device conditional on the current state of a second household device, the server may monitor the current state of the second household device and transmit commands to the first household device upon changes to the state of the second household device. The control data may in some examples only include the user selection, e.g., in the form of an indication of the setting scenario selected by the user, such that the server generates further control data for each involved household devices based on the user selection received by the server. In other examples, the transmitted control data may comprise separate control data for each involved household device.

According to an embodiment, the control data transmitted by the user device 110 may be in encrypted form. A corresponding decryption key (for allowing the household device 105 to decrypt the control data) may be transmitted by the user device 110 or the server 115. For security reasons, the decryption key may for example be transmitted separately (i.e., as a separate data packet) from the control data. According to an embodiment, the decryption key may for example be stored in the household device 105 (e.g., for subsequent decryptions). According to an embodiment, the decryption key may for example be already available in the household device 105 (e.g., as a default setting of the manufacturer of the household device).

According to an embodiment, the method 300 comprises, at the household device 105, upon reception of the control data (action node 355), configuring the household device 105 according to the control data (action node 360).

Then, the method 300 ends.

Although it has been described with respect to FIG. 3 that the method only provides user selectable setting scenarios when the power consumption does not comply with the threshold power consumption, the method may also comprise generating and causing to display user selectable setting scenarios when the power consumption complies with the threshold power consumption. The data processing apparatus may further carry out more than one threshold comparison. It may first check if the power consumption complies with a first threshold power consumption and generate a first set of setting scenarios if the total instant power consumption does not comply with the threshold power consumption. If the total instant power consumption complies with the first threshold power consumption, the data processing apparatus may further check if the total instant power consumption complies with a second threshold power consumption and generate a second set of setting scenarios if the total power consumption does not comply with the second threshold. The data processing apparatus may generate a third set of setting scenarios, or it may provide tips or advice, if the power consumption complies with both threshold power consumptions and the power availability is therefore deemed good. Accordingly, a different set of setting scenarios can be provided for each different visual indication or colour corresponding to a total instant power consumption level. The comparison with either of the first or the second threshold may be carried out has been described above with respect to action node 325.

With reference now to FIGS. 4A-4E, they show exemplary screens displayed on the user device 110 during the power management procedure. Without losing generality, the use case scenario is considered in which opening of the mobile application is caused by the selection of the notification by the user.

With reference to FIG. 4A, starting from a condition in which the user is not actively using the user device 110 (as conceptually represented in the figure by an exemplary home screen), when the mobile application (which, meanwhile, is running in background) assesses that the total instant power consumption does not comply with the threshold power consumption and generates corresponding setting scenarios, a notification indicative that setting scenarios are available is displayed on the user device 110.

Then, selection of the notification by the user triggers the opening of the mobile application (FIG. 4B).

Upon mobile application opening, the setting scenarios and a power consumption bar representing the total instant power consumption with respect to the threshold power consumption, are displayed.

In the example at issue, the power consumption bar is displayed together with a value of the total instant power consumption and with an explanatory text. In the example at issue, the value of the total instant power consumption is 5.6 KW, and the explanatory text recites “The power consumption is HIGH. Select a setting scenario to reduce it”, although this should not be construed limitatively.

In the example at issue, three alternative setting scenarios are displayed, named “Setting scenario A”, “Setting scenario B” and “Setting scenario C”. In the example at issue, each setting scenario is displayed together with basic information about the involved household devices and the respective suggestion.

In the illustrated example, the setting scenario “Setting scenario A” is aimed at allocating power among the household devices to prioritize operation of a kitchen household device with respect to other household devices. In the example at issue, the setting scenario “Setting scenario A” suggests to pause the operation of the washing machine to prioritize (and speed up) the heating up of the oven. Therefore, in this example, the involved household devices are the washing machine and the oven (regardless of whether other household devices are in use and are considered for determining the total instant power consumption). In this example, the setting scenario involves a single setting for each of the two involved household devices, i.e., an operative setting of pausing the washing machine and a parameter setting of high-power setting of the oven.

In the illustrated example, the setting scenario “Setting scenario B” is aimed at limiting the power level of one or more cooking zones of the induction cooking hob to a certain power level while the oven is heating up, thus allocating more power to the oven at the initial phases of the oven operation. Therefore, in this example, the involved household devices are the induction cooking hob and the oven (regardless of whether other household devices are in use and are considered for determining the total instant power consumption). In this example, the setting scenario involves one or more settings of the cooking zones, depending on the number of cooking zones used, conditional on a current state of the oven.

In the illustrated example, the setting scenario “Setting scenario C” is aimed at limiting the power level of the induction cooking hob as long as both the washing machine and the drying machine are in use. Therefore, in this example, the involved household device is the induction cooking hob (regardless of the fact that other household devices, such as the washing machine and the drying machine, are in use and are considered for determining the total instant power consumption). In this example, the setting scenario involves one or more settings of the cooking zones, depending on the number of cooking zones used, conditional on a current state of more than one household device, namely the washing machine and the drying machine.

Then, in response to selection by the user of a setting scenario, detailed information about the parameter settings and/or operative settings (of the involved household devices) corresponding to the selected setting scenario are displayed, possibly together with a dialog box to allow the user to confirm or deny selection (FIG. 4C). Although this is only an example and in other examples no confirmatory dialog box and/or no detailed information is shown.

In the example at issue, the setting scenario “setting scenario B” has been selected. In the example at issue the detailed information associated with the selected setting scenario comprises the instant power consumption (or expected instant power consumption) of the involved household devices (in the illustrated example, 2 KW and 2.5 KW), an indication of an exit condition of the selected setting scenario (in the illustrated example, “the power limit is removed when the oven has reached the target temperature”), an estimated time indicative of an estimated duration of the selected setting scenario (in the illustrated example, 10′), and an estimated power saving determined by the selected setting scenario (in the illustrated example, 500 W).

Upon confirmation of the selected scenario, the corresponding control data is generated, and transmitted to each involved household device, and subsequent configuration of the involved household devices based on the control data takes place. Meanwhile (FIG. 4D), the user device 110 may display a corresponding set up (or configuration) report screen (for example, together with a set up progress status).

Upon set up completion, the user device 110 may display a message indicative of a successful configuration of the selected setting scenario (FIG. 4E).

It will be appreciated that the exemplary screens of FIGS. 4A to 4E correspond to just one non-limiting example of screens, and other screens and information are contemplated. For example, a suggested setting scenario may be to use a household device in ECO mode only, or to switch off the household device all together, while another household device is in operation.

Naturally, in order to satisfy local and specific requirements, a person skilled in the art may apply to the above disclosure many logical and/or physical modifications and alterations. More specifically, although the disclosure has been provided with a certain degree of particularity with reference to embodiments thereof, it should be understood that various omissions, substitutions and changes in the form and details as well as other embodiments are possible. In particular, different embodiments of the disclosure may even be practiced without the specific details (such as the numeric examples) set forth in the preceding description for providing a more thorough understanding thereof; on the contrary, well-known features may have been omitted or simplified in order not to obscure the description with unnecessary particulars.

For example, the present disclosure lends itself to be implemented through an equivalent method (by using similar steps, removing some steps being not essential, or adding further optional steps); moreover, the steps may be performed in different order, concurrently or in an interleaved way (at least partly).

Moreover, the household device (or, more generally, the device or household device) and/or the system may have a different structure or include equivalent components. Moreover, any component of the household device (or, more generally, the household device) and/or the system may be separated into several elements, or two or more components may be combined into a single element; furthermore, each component can be replicated to support the execution of the corresponding operations in parallel. It should also be noted that (unless otherwise indicated) any interaction between different components generally does not need to be continuous and may be either direct or indirect through one or more intermediaries

1. A computer implemented method for managing a plurality of household devices associated with a user, the method comprising:
if an instant power consumption of the plurality of household devices does not comply with a threshold power consumption:
providing a plurality of setting scenarios for allowing the instant power consumption of the plurality of household devices to comply with the threshold power consumption, each setting scenario of the plurality of setting scenarios corresponding to at least one of:
(i) one or more settings of each of more than one household device of the plurality of household devices; and
(ii) one or more settings of at least one first household device of the plurality of household devices conditional on a current state of at least one second household device of the plurality of household devices;
receiving a user selection of a setting scenario among the plurality of setting scenarios, and
generating control data for automatically controlling said more than one household device and/or said at least one first household device according to the setting scenario corresponding to the received user selection.

2. The method according to claim 1, wherein said providing the plurality of setting scenarios comprises causing to display, on a user interface, the plurality of setting scenarios.

3. The method according to claim 2, wherein said generating the control data is performed in response to a single user input, through the user interface, for said more than one household device and/or said at least one first household device.

4. The method according to claim 3, wherein said single user input comprises said user selection.

5. The method according to claim 1, wherein the instant power consumption complies with the threshold power consumption if the instant power consumption does not exceed the threshold power consumption.

6. The method according to claim 1, wherein the instant power consumption does not comply with the threshold power consumption if the instant power consumption exceeds or is likely to exceed the threshold power consumption.

7. The method according to claim 1, wherein the instant power consumption does not comply with the threshold power consumption if the instant power consumption is lower than the threshold power consumption by an amount equal to or smaller than a predefined amount indicative of a closeness between the instant power consumption and the threshold power consumption, and wherein the instant power consumption complies with the threshold power consumption if the instant power consumption is lower than the threshold power consumption by an amount greater than the predefined amount.

8. The method according to claim 1, further comprising causing to provide an indication, of the instant power consumption of the plurality of household devices.

9. The method according to claim 8, wherein said indication comprises a visual indication comprising a color.

10. The method according to claim 8, wherein said indication depends on the instant power consumption as compared to the threshold power consumption.

11. The method according to claim 2, wherein the user interface comprises one or more user interfaces of at least one household device of the plurality of household devices.

12. The method according to claim 2, wherein the user interface comprises a user interface of a data processing apparatus associated with, or accessible by, a user of the plurality of household devices.

13. The method according to claim 12, wherein the data processing apparatus comprises at least one of a mobile device, a smartphone, a tablet, a wearable device, a non-mobile device, a laptop computer, and a desktop computer.

14. The method according to claim 1, further comprising receiving one or more user commands to add one or more household devices to the plurality of household devices and/or to remove one or more household devices from the plurality of household devices.

15. The method according to claim 1, wherein said plurality of household devices comprises supported household devices supporting power consumption measurements, the method further comprising determining the instant power consumption of the plurality of household devices based on said power consumption measurements.

16. The method according to claim 15, wherein said plurality of household devices comprises unsupported household devices not supporting the power consumption measurements, and wherein said determining the instant power consumption of the plurality of household devices being based, for each unsupported household device, on a respective power consumption indication or estimate.

17. The method according to claim 16, wherein said power consumption indication or estimate is based on a type of household device.

18. The method according to claim 1, wherein the threshold power consumption is based on an available power being available to the user or on a fraction of the available power being selected by the user.

19. A data processing apparatus comprising at least one processor and a memory storage operatively coupled to the at least one processor and configured to store instructions that, when executed, configure the at least one processor to:
assess whether an instant power consumption of a plurality of household devices complies with a threshold power consumption;
if the instant power consumption does not comply with the threshold power consumption:
provide a plurality of setting scenarios for allowing the instant power consumption of the plurality of household devices to comply with the threshold power consumption, each setting scenario of the plurality of setting scenarios corresponding to at least one of:
(i) one or more settings of each of more than one household device of the plurality of household devices;
(ii) one or more settings of at least one first household device of the plurality of household devices conditional on a current state of at least one second household device of the plurality of household devices;
cause to display, on a user interface of the data processing apparatus, the plurality of setting scenarios for user selection;
receive a selection of a setting scenario among the displayed plurality of setting scenarios;
generate control data for causing automatic control of said more than one household device and/or said at least one first household device according to the setting scenario corresponding to the received selection, and transmit said control data for causing said automatic control.

20. The data processing apparatus according to claim 19, wherein the data processing apparatus comprises at least one of a mobile device, a smartphone, a tablet, a wearable device, a non-mobile device, a laptop computer, and a desktop computer.

21. A system comprising:
the data processing apparatus of claim 19; and
a household device comprising:
measuring circuitry configured to measure an instant power consumption of the household device;
communication circuitry configured to communicate the measured instant power consumption of the household device to the data processing apparatus and to receive from the data processing apparatus said control data, and
control circuitry configured to control an operation of the household device based on the received control data.

22. A computer program product directly loadable into an internal memory storage of a data processing apparatus, the computer program product comprising software code means for, when the computer program product is run on the data processing apparatus, configuring at least one processor of the data processing apparatus to:
if an instant power consumption of a plurality of household devices does not comply with a threshold power consumption:
cause to display on a user interface of the data processing apparatus a plurality of setting scenarios for allowing the instant power consumption of the plurality of household devices to comply with the threshold power consumption, each setting scenario of the plurality of setting scenarios corresponding to at least one of:
(i) one or more settings of each of more than one household device of the plurality of household devices; and
(ii) one or more settings of at least one first household device of the plurality of household devices conditional on a current state of at least one second household device of the plurality of household devices;
receive a user selection of a setting scenario among the plurality of setting scenarios;
generate control data for causing automatic control of said more than one household device and/or said at least one first household device according to the setting scenario corresponding to the received user selection; and
cause transmission of said control data for causing said automatic control.
